(19) United States
(12) Patent Application Publication
(10) Pub. No.: US 2013/0085886 A1
(43) Pub. Date: Apr. 4, 2013

(54) METHOD AND SYSTEM FOR AUTOMATIC APPLICATION RECOMMENDATION

(71) Applicants: Sourabh Satish, Fremont, CA (US); Jing Zhou, Marina Del Rey, CA (US); Abubakar Wawda, Sunnyvale, CA (US)

(72) Inventors: Sourabh Satish, Fremont, CA (US); Jing Zhou, Marina Del Rey, CA (US); Abubakar Wawda, Sunnyvale, CA (US)

(73) Assignee: SYMANTEC CORPORATION, Mountain View, CA (US)

(21) Appl. No.: 13/249,095

(22) Filed: Sep. 29, 2011

(51) Int. Cl. G06Q 30/02

(52) U.S. Cl. 705/26.7

(57) ABSTRACT

A system and method of automatic suggested application identification includes accessing a profile of a device, wherein the profile represents information specific to the device. From said profile, a determined pattern of use determined by the device is accessed, wherein the determined pattern is unique to the device. The profile including the determined pattern and a geo-specific data of the device and configuration information of the device and applications resident on the device is compared to similar profiles and similar determined patterns of other devices. A suggested application is identified based on said comparing.

### FIELD

Embodiments according to the present invention generally relate to computer systems, in particular to application distribution systems and servers.

### BACKGROUND

Traditionally, computer users have purchased computer programs (e.g. applications) at brick-and-mortar computer stores. The users may have decided to purchase an application responsive to some exposure to the product, e.g. after reading magazine or online articles that reviewed one or more applications. The users then went to the store and double-checked the “box” (e.g. the packaging containing the application) to verify that their system met the minimum requirements needed to run the application. The minimum requirements typically listed the minimum processor speed, memory, hard drive space, etc. needed to run the application.

More recently, computer users advantageously purchase applications online. Furthermore, computer applications have expanded to include computer applications for many different computer devices, e.g. smart phones, tablet computers, laptop computers, desktop computers, etc. Online market places, e.g. Android Market, App Store, etc., now allow users to preview and purchase thousands of applications online which can be downloaded seamlessly to a computer system, e.g. handheld device.

In addition to listing system requirements, online market places may also list other information pertinent to an application, e.g. an application's popularity, user ratings, and user reviews. An application's popularity may correlate to the number of times an application has been purchased and downloaded. However, the popularity measured in downloads does not indicate how often or how many times a user actually uses a downloaded application.

An application's user ratings give a better idea of how users actually liked a downloaded application, e.g. by allowing users to rate the application one to five stars. However, rankings and comments/reviews can be artificially manipulated by biased users, e.g. employees working for (or against) the company that developed the application.

An application's user reviews allow users to leave specific details about why they liked or did not like an application. However as with the user ratings, the user reviews can be manipulated. Furthermore, the user reviews take longer to read and do not provide a quick overview of an application, nor can they readily be automatically processed for concise summary.

In addition to the problems listed above, online market places do not suitably consider a user's unique device environment. For example, an individual user may download a highly rated application with good reviews onto a device with the minimum system requirements. However, the individual user may later discover that there are other applications already installed on the device that conflict with or supersede the new application, thus rendering the new application useless or less useful.

### SUMMARY

Embodiments of the present invention are directed to a method and system for automatic application recommendation by an application distribution system. The automatic application recommendation system of the embodiments of the present invention enable a computer system to automatically recommend an application to a user based on: associating a user's profile to other similar profiles of other users; device compatibility profile; and/or the user's selections of applications. The profiles described above are maintained by the user device and are specific to the user device. In some embodiments, the system may inform a user of the suitability of an application, or inform the user of additional applications that may be of interest to the user.

Therefore, embodiments of the present invention automatically recommend applications based on the analysis and comparison of user metrics. The user metrics are variable and combine to comprise a dynamic user profile. For example, one user metric may measure and identify the specific applications downloaded by a user in separate categories, e.g. a category sorted list of applications. Another example user metric may measure the user's system profile, e.g. device model, device manufacturer, memory, available resources, etc. Still another example user metric may measure the geo-location of the user's device. The user profile may also measure the actual usage of the various applications installed on the user device. Thus, a number of non-static user metrics may be included in a user's profile, the user's profile may be compared to similar profiles of other users, and an application may be recommended based on the comparison.

In one embodiment, a method of automatic suggested application identification includes: accessing a profile of a device, wherein the profile represents information specific to the device; from the profile, accessing a determined pattern of use of applications as determined by the device, wherein the determined pattern is unique to the device; comparing the profile including the determined pattern of use to similar profiles and similar determined patterns of use of other devices; and based thereon automatically identifying a suggested application based on results of the comparing.

In further embodiments an adaptive engine automatically performs the comparing and the identifying. In some embodiments, method further includes communicating the suggested application to the device, and automatically updating the adaptive engine in response to whether or not the device downloads the suggested application.

In various embodiments, the profile is a dynamic configuration of the device comprising: geography of the device; system resources of the device; and category sorted list of applications on the device. In some embodiments, in response to receiving a user selection of an application for download, the method further includes automatically communicating a notification to the user whether the application for download is suitable based on the determined pattern and the profile.

In one embodiment, the determined pattern of use includes: frequency of applications used on the device; a list of applications installed on the device; and a list of applications removed from the device. In another embodiment, the device is a mobile device. In some embodiments, the method further includes selecting the similar determined patterns based on geolocation.

In another embodiment, a method of automatic recommendation includes: receiving device information on a server from a remote device; associating the device information with comparable device information collected from further remote devices and stored on said server; and recommending a downloadable program to a user of the device based on results of the associating.

In some embodiments device information is a dynamic configuration of the device comprising: geography information of the device; system resources of the device; category sorted applications of the device; and use patterns of applications as used by the device. In further embodiments, the recommending is performed in response to receiving user selections of the user in an online application store.

In various embodiments, device information includes: a use measurement of applications used on the device; a list of applications removed from the device, and a categorical list of the applications on the device. In some embodiments the method further includes recommending a downloadable program pack to the user based on the associating, wherein the downloadable program pack includes a plurality of complementary programs.

In one embodiment, the remote device is a mobile computer system. In various embodiments, device information and the comparable device information include geolocation information pertinent to the devices.

In another embodiment, a system is described including: a processor; and memory coupled to the processor, wherein the memory includes instructions that when executed cause the system to perform a method of automatic application recommendation, the method including: receiving a profile of a device, wherein the profile represents information specific to the device wherein the profile comprises a determined pattern of use as determined on said device; comparing the profile to similar profiles of other devices; transmitting a suggested application based on the results of the comparing to the device; and updating an adaptive engine in response to changes in the profile, wherein the adaptive engine automatically executes the comparing and the transmitting.

In some system embodiments, the profile of the device comprises: geography of the device; hardware configuration of the device; applications on the device; and system resources on the device. In further system embodiments, the method includes in response to receiving a user selection of an application for download, automatically forwarding a notification to the user whether the new application is unsuitable for the device based on the profile of the device.

In one system embodiment, the pattern of use includes: frequency of applications used on the device; a list of applications installed on the device; and a list of applications removed from the device. In various system embodiments, the device is a desktop computer system. In one system embodiment, the method further includes selecting the similar profiles based on geolocation.

These and other objects and advantages of the various embodiments of the present invention will be recognized by those of ordinary skill in the art after reading the following detailed description of the embodiments that are illustrated in the various drawing figures.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 is a block diagram depicting an exemplary network architecture that can serve as a platform for embodiments of the present invention.

FIG. 2 is a block diagram depicting a computer system suitable for implementing embodiments of the present invention.

FIG. 3 is a block diagram of an application distribution and recommendation system, according to an embodiment of the present invention.

FIG. 4 is a block diagram of the application distribution and recommendation system including a number of users' profiles, according to an embodiment of the present invention.

FIG. 5 is a block diagram of an exemplary user device, according to an embodiment of the present invention.

FIG. 6 is a block diagram of the application distribution and recommendation system including a fuzzy cluster, according to an embodiment of the present invention.

FIG. 7 depicts an exemplary computer controlled flow diagram of a method of automatic suggested application identification, according to an embodiment of the present invention.

FIG. 8 depicts an exemplary computer controlled flow diagram of a method of automatic recommendation, according to an embodiment of the present invention.

FIG. 9 depicts an exemplary computer controlled flow diagram of a method of automatic application distribution and recommendation, according to an embodiment of the present invention.

### DETAILED DESCRIPTION

Reference will now be made in detail to embodiments in accordance with the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “encoding,” “decoding,” “receiving,” “sending,” “using,” “applying,” “calculating,” “incrementing,” “comparing,” “selecting,” “summing,” “weighting,” “computing,” “accessing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

By way of example, and not limitation, computer-usable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

In the discussion that follows, unless otherwise noted, a “connected” refers to communicatively coupling elements via a bus, wireless connection (wifi), Bluetooth, infrared, USB, Ethernet, FireWire, optical, PCI, DVI, etc.

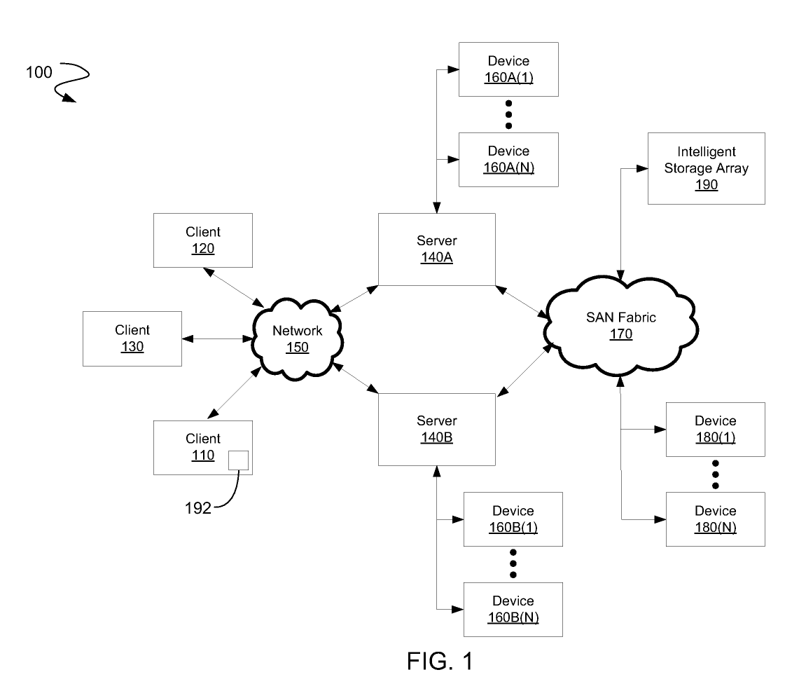

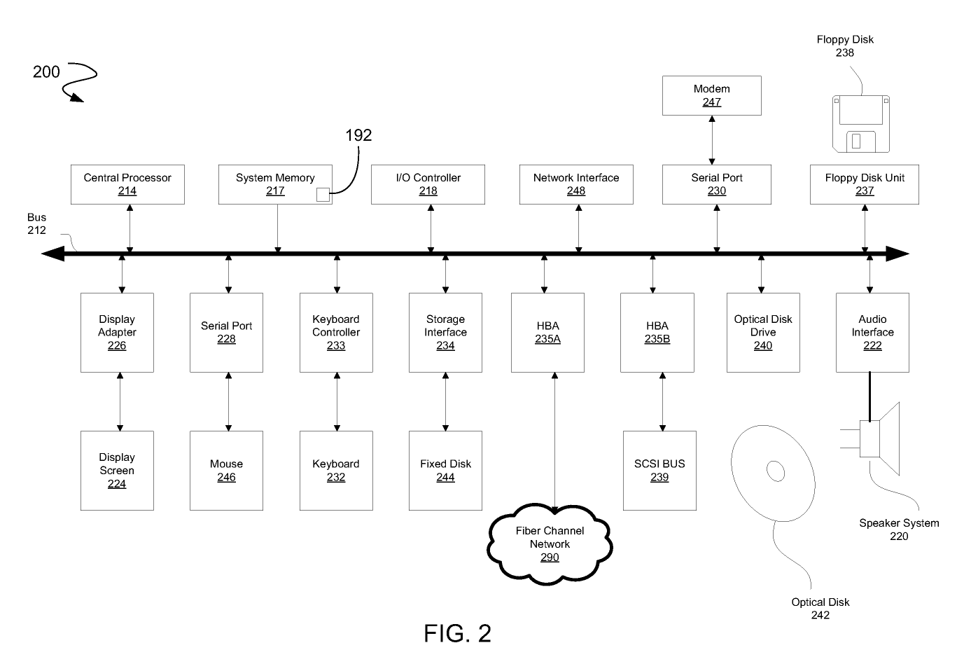

FIG. 1 is an exemplary system in which embodiments of the present invention can be implemented for automatic application distribution and recommendation. FIG. 1 is a block diagram depicting a network architecture 100 in which client systems 110, 120, and 130, as well as storage servers 140A and 140B (any of which can be implemented using computer system 200 (FIG. 2)), are coupled to a network 150. Storage server 140A is further depicted as having storage devices 160A(1)-(N) directly attached, and storage server 140B is depicted with storage devices 160B(1)-(N) directly attached. Servers 140A and 140B may contain a plurality of files that may be shared among a plurality of users. Storage servers 140A and 140B are also connected to a SAN fabric 170, although connection to a storage area network is not required for operation of the disclosure. SAN fabric 170 supports access to storage devices 180(1)-(N) by storage servers 140A and 140B, and so by client systems 110, 120, and 130 via network 150. Intelligent storage array 190 is also shown as an example of a specific storage device accessible via SAN fabric 170.

With reference to computer system 200 (see FIG. 2), modem 247 (see FIG. 2), network interface 248 (see FIG. 2), or some other method can be used to provide connectivity from each of client computer systems 110, 120, and 130 to network 150. Client systems 110, 120, and 130 of FIG. 1 are able to access information on storage server 140A or 140B using, for example, a web browser or other client software (not shown). Such a client allows client systems 110, 120, and 130 to access data hosted by storage server 140A or 1408 or one of storage devices 160A(1)-(N), 160B(1)-(N), 180(1)-(N), or intelligent storage array 190. FIG. 1 depicts the use of a network such as the Internet or exchanging data, but the embodiments of the present invention are not limited to the Internet or any particular network-based environment. In the present embodiments, a method of automatic application recommendation 192 may be performed in one of the client computer systems 110, 130, and 130. However, the method of automatic application recommendation 192 is not limited to the client computer systems 110, 130, and 130, and may also operate within, for example, storage server 140A or 140B. In addition, the method of automatic application recommendation 192 may also operate within cloud computing environments.

FIG. 2 depicts a block diagram of a computer system 200 suitable for implementing embodiments of the present invention. In the discussion to follow, various and numerous components and elements are described. Various combinations and subsets of those components can be used to implement the devices mentioned in conjunction with FIG. 1. For example, client systems 110, 120, and 130 may each be a full-function computer system that employs many, if not all, of the features of the computer system 200. However, the servers 140A and 1408 may utilize only the subset of those features needed to support the functionality provided by those devices. For example, the servers 140A and 140B may not need a keyboard or display, and may execute a relatively sparse operating system that supports the functionality of data storage and data access and the management of such functionality.

Computer system 200 of FIG. 2 includes a bus 212 which interconnects major subsystems of computer system 200, such as a central processor 214, a system memory 217 (typically RAM, but which may also include ROM, flash RAM, or the like), an input/output controller 218, an optional external audio device, such as a speaker system 220 via an audio output interface 222, an optional external device, such as a display screen 224 via display adapter 226, serial ports 228 and 230, an optional keyboard 232 (interfaced with a keyboard controller 233), an optional storage interface 234, an optional floppy disk unit 237 operative to receive a floppy disk 238, an optional host bus adapter (HBA) interface card 235A operative to connect with a Fibre Channel network 290, an optional host bus adapter (NBA) interface card 235B operative to connect to a SCSI bus 239, and an optional optical disk drive 240 operative to receive an optical disk 242. Also, optionally included can be a mouse 246 (or other point-and-click device, coupled to bus 212 via serial port 228), a modem 247 (coupled to bus 212 via serial port 230), and a network interface 248 (coupled directly to bus 212).

Bus 212 allows data communication between central processor 214 and system memory 217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 200 are generally stored on and accessed via a computer readable medium, such as a hard disk drive (e.g., fixed disk 244), an optical drive (e.g., optical drive 240), a floppy disk unit 237, or other storage medium. Additionally, applications can be in the form of electronic signals modulated in accordance with the application and data communication technology when accessed via network modem 247 or network interface 248. In the current embodiment, the system memory 217 comprises instructions that when executed cause the system to perform the method of automatic application recommendation 192.

Storage interface 234, as with the other storage interfaces of computer system 200, can connect to a standard computer readable medium for storage and/or retrieval of information, such as fixed disk drive 244. Fixed disk drive 244 may be part of computer system 200 or may be separate and accessed through other interface systems. Modem 247 may provide a direct connection to a remote server via a telephone link or to the Internet via an internet service provider (ISP). Network interface 248 may provide a direct connection to a remote server via a direct network link to the Internet via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 2 need not be present to practice the present disclosure. The devices and subsystems can be interconnected in different ways from that shown in FIG. 2. The operation of a computer system such as that shown in FIG. 2 is readily known in the art and is not discussed in detail in this application. Code to implement the present disclosure can be stored in computer-readable storage media such as one or more of system memory 217, fixed disk 244, optical disk 242, or floppy disk 238. The operating system provided on computer system 200 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

### Method and System for Automatic Application Distribution and Recommendation

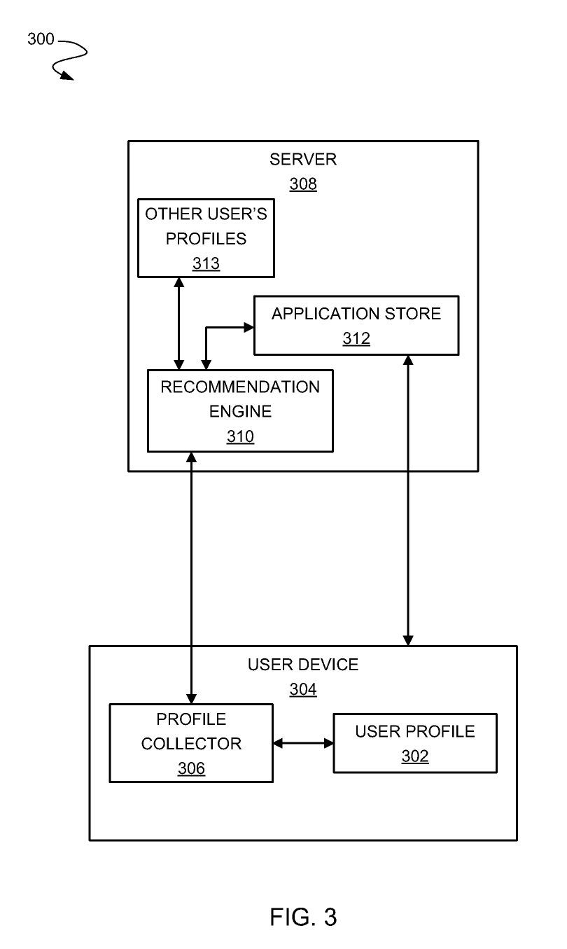

FIG. 3 depicts an exemplary block diagram of an application distribution and recommendation system 300, according to an exemplary embodiment of the present invention. Embodiments of the present invention enable a system to automatically recommend an application to a user based on associating the user's individual profile to other similar profiles of other users. In some embodiments, the system may inform a user of the suitability of an application, or inform the user of additional applications that may be of interest to the user. Based on an individual user profile, maintained by the user device, the application recommendation can be very effective and targeted to the particular user and user device.

Typically, application stores provide recommendations for applications on the basis of aggregated download counts and on the basis of user reviews and ratings. However, recommendations on the basis of an application's download count assume that all devices and users have similar profiles and needs. Furthermore, recommendations on the basis of an application's user reviews and ratings can be gamed, e.g. manipulated by users interested in promoting or demoting the application.

On the other hand, embodiments of the present invention recommend applications based on an analysis and comparison of user and user device metrics. The metrics are variable and combine to comprise a dynamic user profile. For example, one user metric may measure and identify the specific applications downloaded by a user in separate categories, e.g. a category sorted list of applications. Another example user metric may measure the user's system profile of the device, e.g. model, manufacturer, memory, available resources, etc. Still another example user metric may measure the geo-location of the user's device. An important metric also measures the actual usage by the user of the applications on the device. Thus, a number of non-static user metrics may be included in a user's profile, the user's profile may be compared to similar profiles of other users, and an application may be recommended based on the comparison.

An embodiment of the application recommendation system 300 of the present invention automatically collects a user profile 302 from a user device 304 with a profile collector 306. The profile collector 306 may be any software agent, profile generator program, application, and/or hardware device that automatically collects information specific to the user profile 302 from the user device 304 to generate/update the user profile. In the present embodiment the profile collector 306 may reside on the user device 304, e.g. smart phone, tablet computer, laptop computer, desktop computer, etc. However, in other embodiments the profile collector 306 may be external to the user device 304, e.g. the profile collector 306 may alternatively be located on server 308.

In embodiments of the present invention, the user profile 302 is dynamic and comprises a number of metrics collected from the user device 304. For example, in one embodiment a frequency metric may measure the number of times the user device 304 is instructed by the user to run an application and for the length of time each application is used. Over time, the frequency metric may adjust as the user's pattern of application use changes. Therefore, the user profile 302 will update over time as one or more metrics revise. The frequency metric may also record whether or not an application is removed from the device, e.g. uninstalled.

In an embodiment, the server 308 includes a recommendation engine 310 and an application store 312. However, in other embodiments the recommendation engine 310 and/or the application store 312 may be located elsewhere, e.g. on different servers, on the user device 304, or another user's device (not shown). The recommendation engine 310 receives the user profile 302 from the user device 304, e.g. from the profile collector 306. The recommendation engine 310 automatically compares the user profile 302 to other users' profiles 313 that have been gathered by the recommendation engine 310.

The user may access the application store 312 with the user device 304, e.g. with a web browser, purchase application, etc. When the user selects an application for purchase and/or download, or in response to the user requesting application information and/or a suggestion, the recommendation engine 310 may provide a recommendation to the user based on comparing the user profile 302 to the other users' profiles 313. For example, the recommendation engine 310 may inform the user that a selected application is not suitable for the user device 304, or may recommend a new application or suite of applications to the user. In various embodiments recommended applications may be automatically customized for a given user's language and/or region.

In some embodiments, the recommendation engine 310 based on the user profile may suggest an alternate application that is suitable for the user device 304. In further embodiments, the recommendation engine 310 based on the user profile may suggest additional related or companion applications that are suitable for the user device 304. In various embodiments, the recommendation engine 310 based on the user profile may suggest suitable applications or groups of applications prior to the user selecting an application. For example, the recommendation engine 310 may suggest a number of suitable applications for the user device 304 when the user first connects to the application store 312.

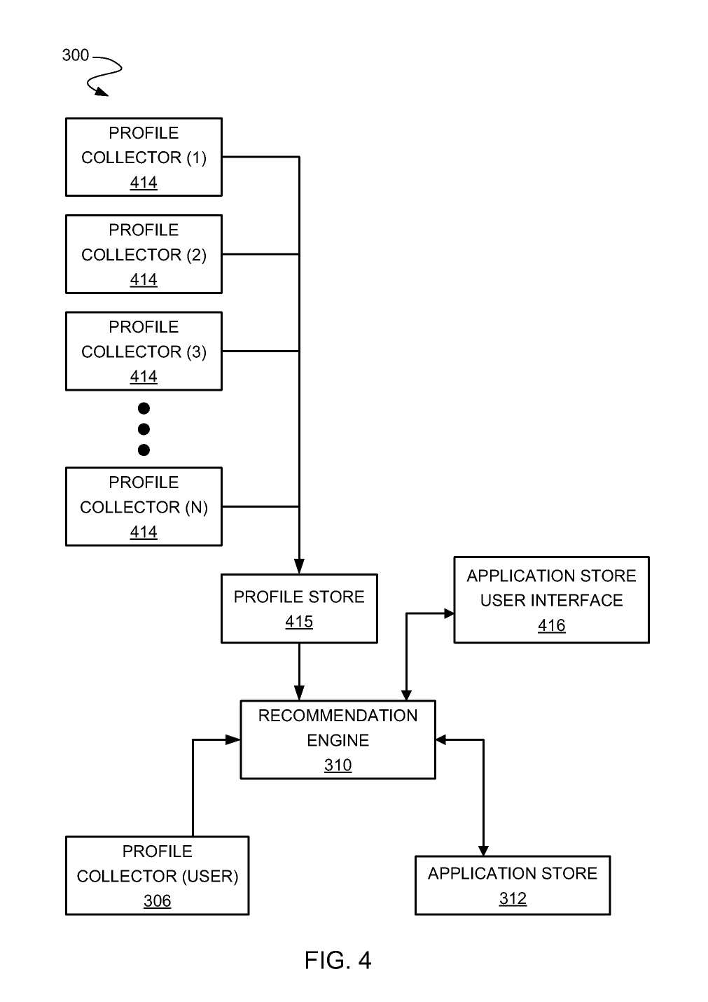

FIG. 4 depicts an exemplary block diagram of the application recommendation system 300 including a number of users' profiles, according to an exemplary embodiment of the present invention. In an embodiment, the recommendation engine 308 collects device information, e.g. profiles and determined patterns of use, from a number of profile collectors 414(1)-(N) corresponding to a number of devices (not shown), e.g. smart phone, tablet computer, laptop computer, desktop computer, etc., and stores them into a profile store 415. The recommendation engine 308 associates the user's device information from the profile collector 306 with comparable device information received from the number of profile collectors 414(1)-(N). For example, the user's device information may be associated with comparable devices based on geo-specific device location, device system resources, category of installed applications, frequency of applications used, similar installed applications, use patterns of applications, hardware configuration of the device, possible incompatibilities, bandwidth metrics, network usage metrics, total memory, available memory, etc.

In an embodiment, the recommendation engine 310 automatically makes application suggestions to the user, e.g. through an application store user interface 416, based on the associating. For example, the recommendation engine 310 may discover that the user has installed a first program. The recommendation engine 310 then analyzes the device profiles of other comparable devices, and discovers that other users of the same or similar geo-specific location and who have the first program installed typically install a second program. The recommendation engine 310 then recommends the second program to the user. In various embodiments recommended applications may be automatically customized for a given user's language and/or region.

In another example, the application store user interface 302 may communicate to the recommendation engine 310 that a user has selected an application for purchase. The recommendation engine 310 then analyzes the device profiles of other comparable devices and concludes that other devices that have the requested application for purchase installed typically experience instability, crash more often, and/or have a high rate of uninstallation of the requested application for purchase. Therefore, the recommendation engine 310 recommends that the user not purchase the application. In further embodiments, the recommendation engine 310 may suggest alternate applications based on the analyzing.

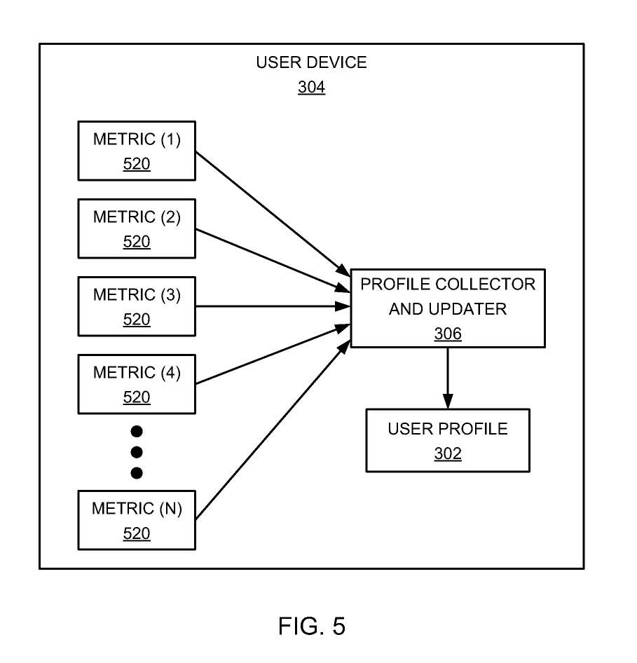

FIG. 5 depicts an exemplary block diagram of the user device 304, according to an exemplary embodiment of the present invention. In some embodiments the profile collector 306 is a profile collector and updater. In an embodiment, the user device 304 includes the profile collector 306. However, in alternate embodiments the user device 304 may not include the profile collector 306, e.g. the server 308 (FIG. 3) may include the profile collector 306. In an embodiment, the profile collector 306 may calculate (or collect, measure, record, etc.) a number of metrics 520(1)-(N). The number of metrics 520(1)-(N) are specific to the user device 304 (e.g. they are measured from the user device 304).

Furthermore, a determined pattern of application use and device configuration information and other device specific information created from the number of metrics 520(1)-(N) may be unique to the user device 304, the same as other devices (not shown), and/or similar to other devices (not shown). For example, the number of metrics 520(1)-(N) unique to the user device 304 may include serial number, exact geo-location, IP address, etc. The number of metrics 520(1)-(N) that are the same as other devices may include total installed memory, operating system, an installed program, hardware configuration, etc. The number of metrics 520(1)-(N) that are similar to other devices may include available memory, frequency of application use, types of applications installed, system resources, etc. The examples of the number of metrics 520(1)-(N) listed above may shift between the classifications of “unique,” “same,” and “similar” depending on the devices that are being compared. Further examples of determined patterns of use that may be measured by the number of metrics 520(1)-(N) include: frequency of applications used on the device; similar applications installed on the device; types of applications installed on the device; similar applications deleted on the device; and types of applications deleted on the device. All of the above user and user device specific information may be collected and stored into the user profile.

Thus, embodiments of the present invention may use the metric information collected by the profile collector 306 to automatically identify specific applications for recommendation to the user. As described above, the recommendation engine 310 (FIG. 3) accesses the user profile 302 from the profile collector 306 of the user device 304. The recommendation engine 310 (FIG. 3) compares the user profile 302 (FIG. 3) to similar user profiles to identify specific applications users download in each category (e.g. user choices), the system profile, geo-location, etc. In various embodiments recommended applications may be automatically customized for a given user's language and/or region.

For example, for a given user the application recommendation system 300 may know that a first user has a specific platform by model/manufacturer (for example Android Motorola ATRIX 4G), is in a specific geographic location (San Jose, Calif., North America), and in the Games/Strategy category has downloaded/updated a first application (e.g. Angry Birds). At a later point, the first user may download another application game (e.g. Phage) in the Games/Strategy category. The application recommendation system 300 may then automatically suggest to another user who has the first application installed that other users with the first application installed also have the second application installed (e.g. “As a user of Angry Birds, you might also enjoy Phage”).

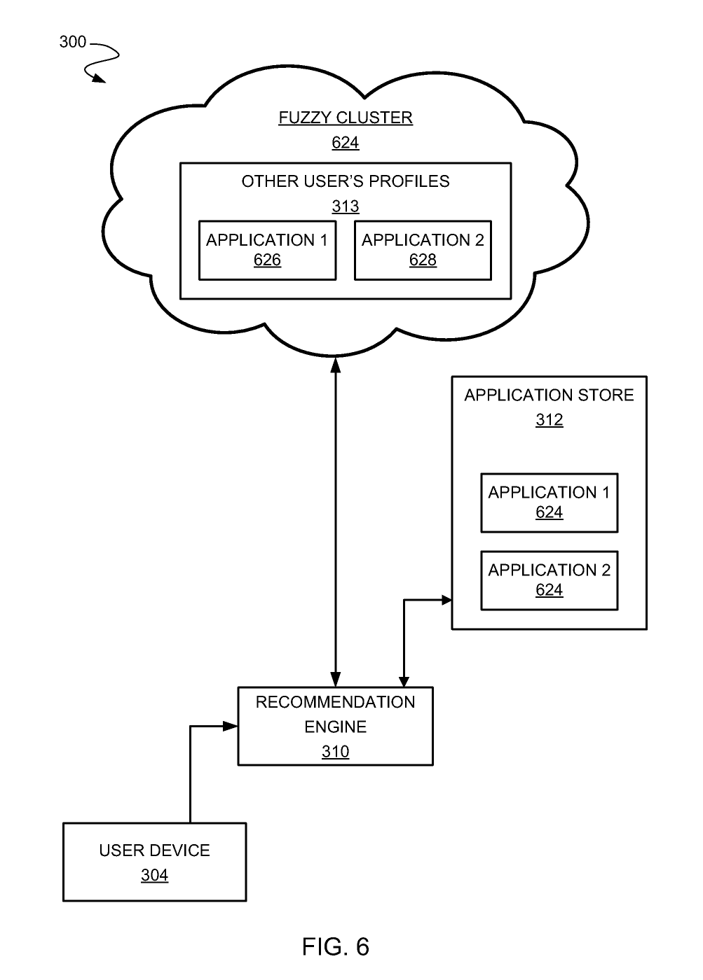

FIG. 6 depicts a block diagram of the application recommendation system 300 including a fuzzy cluster 624, according to an exemplary embodiment of the present invention. Embodiments of the present invention may group together the other user's profiles 313 into fuzzy clusters. Thus, the other user's profiles 313 may be clustered according to one or more of the metrics 520(1)-(N) (FIG. 5). For example, users with similar usage patterns may be grouped into the fuzzy cluster 624. The fuzzy cluster 624 may then be data mined and/or analyzed by the recommendation engine 310 to determine other characteristics of the fuzzy cluster 624.

Furthermore, fuzzy clustering allows the same user profile to be associated with distinct clusters at the same time. Thus, the application recommendation system 300 may recommend specific and relevant applications to the user device 304 on the basis of shared profile attributes. For example, a user who downloads Application(1) 626, e.g. “Angry Birds,” from the Games/Strategy category on an Android Motorola ATRIX 4G system in San Jose may be recommended Application(2) 628, e.g. “Phage,” from the Game/Strategy category of the application store 312, because the analytics of the recommendation engine 310 recognize that “Phage” is the most popular game for all “Angry Bird” users generally or specifically on the basis of other profile attributes, system specifications, and geo-location.

In response to the recommendation, users may choose whether or not to pursue the recommendation. In some embodiments, the recommendation engine 310 learns from users choices and automatically adjusts future recommendations on the basis of what the user eventually downloads. Thus, the application recommendation system 300 is a multi-faceted profile system in which the recommendation engine 310 adjusts recommendations based on one or more profile attributes, e.g. the metrics 520(1)-(N) (FIG. 5).

In various embodiments, the recommendation engine 310 may build a recommendation pack for recommendation to the user device 304. For example, the recommendation engine 310 may group together a number of applications based on suitability for the user device 304 and application category. The recommendation engine 310 suggests the recommendation pack to the user device 304, where a user may choose to download one or more of the applications in the recommendation pack. In further examples, the recommendation engine 310 may build and suggest the recommendation pack based on system specifications, geo-location, or a user choice profile created by letting the user make a few initial application choices on a new device.

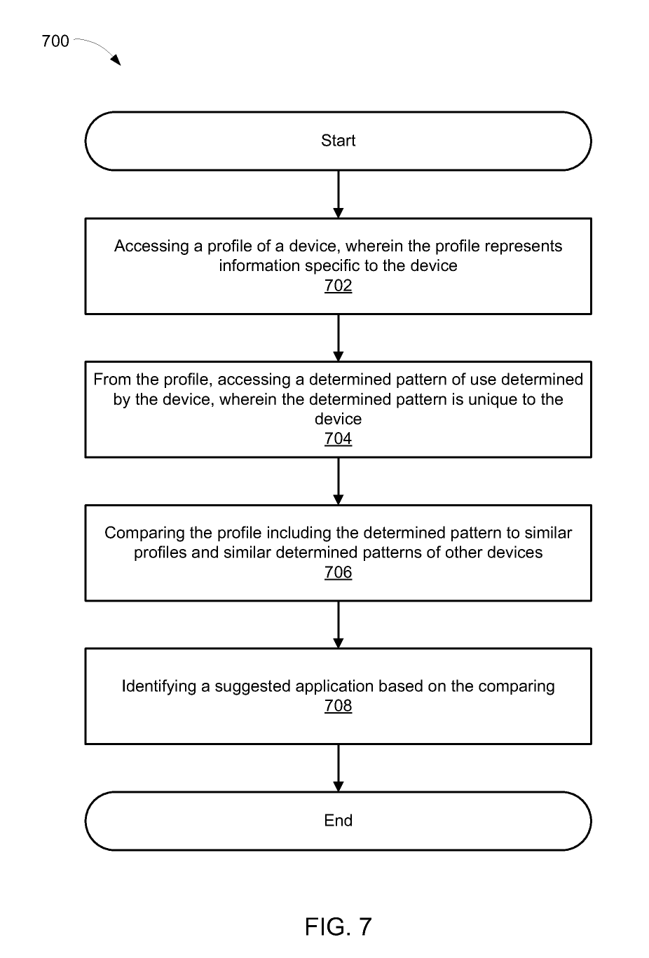

FIG. 7 depicts a flowchart 700 of an exemplary computer controlled method of automatic suggested application identification, according to an embodiment of the present invention. Although specific steps are disclosed in the flowchart 700, such steps are exemplary. That is, embodiments of the present invention are well-suited to performing various other steps or variations of the steps recited in the flowchart 700. The flowchart 700 can be implemented as computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In a step 702, a profile of a device is accessed, wherein the profile represents information specific to the device. For example, in FIG. 3 a user profile is generated and dynamically updated by a user device with a profile collector. The profile collector may be any software, agent program, application, and/or hardware device that automatically collects information specific to the user profile from the user device.

In some embodiments, the profile is a non-static configuration of the device including: application usage information of the above; the geography of the device; system resources of the device; and a category sorted list of applications on the device. For example, in FIG. 3 user metrics are variable and combine to comprise a dynamic user profile. For example, one user metric may measure and identify the specific applications downloaded by a user in separate categories, e.g. a category sorted list of applications. Another example user metric may measure the user's system profile, e.g. model, manufacturer, device configuration (e.g. operating system type), memory, available resources, etc. Still another example user metric may measure the geo-location of the user's device. Thus, a number of non-static user metrics may be included in a user's profile.

In a step 704, from the profile, a determined pattern of use determined by the device is accessed, wherein the determined pattern is unique to the device. For example, in FIG. 5 a determined pattern of application use created from the number of metrics may be unique to the user device.

In some embodiments, the pattern of use includes: frequency of applications used on the device; similar applications installed on the device; types of applications installed on the device; similar applications deleted on the device; and types of applications deleted on the device. For example, in FIG. 5 the number of metrics may include serial number, exact geo-location, IP address, memory, operating system, an installed program, hardware configuration, available memory, frequency of application use, types of applications installed, system resources, frequency of applications used on the device, similar applications installed on the device, types of applications installed on the device, similar applications deleted on the device, types of applications deleted on the device, etc.

In a step 706, the profile including the determined pattern is compared to similar collected profiles and similar collected determined patterns of other devices. For example, in FIG. 3 the recommendation engine receives the user profile from the user device, e.g. from the profile collector. The recommendation engine compares the user profile to other users' profiles that have been gathered and stored by the recommendation engine.

In some embodiments the device is a mobile device. For example, in FIG. 3 the user device may be a smart phone, tablet computer, laptop computer, desktop computer, etc. In various embodiments, the similar determined patterns are selected based on geolocation. For example, in FIG. 5 the recommendation engine compares the user profile to similar user profiles to identify specific applications users download in each category (e.g. user choices), the system profile on which they downloaded the applications, geo-location, etc.

In a step 708, a suggested application is automatically identified based on the results of the comparing. For example, in FIG. 5 the application recommendation system may suggest to another user who has the first application installed that other users with the first application installed also have the second application installed (e.g. “As a user of Angry Birds, you might also enjoy Phage”).

In some embodiments, an adaptive engine automatically performs the comparing and the identifying. For example, in FIG. 3 the recommendation engine receives the user profile from the user device, e.g. from the profile collector. The recommendation engine automatically compares the user profile to other users' profiles that have been gathered and stored by the recommendation engine, and provides a recommendation to the user based on comparing the user profile to other user's profiles.

In further embodiments, the suggested application is communicated to the device. For example, in FIG. 3 the user may access the application store with the user device, e.g. with a web browser, purchase application, etc. When the user selects an application for purchase and/or download, the recommendation engine may provide a recommendation to the user based on comparing the user profile to other users' profiles. For example, the recommendation engine may inform the user that a selected application is not suitable for the user device.

In various embodiments, the adaptive engine is automatically updated in response to whether or not the device actually downloads the suggested application. For example, in FIG. 6 the recommendation engine learns from users choices and automatically adjusts future recommendations on the basis of what the user eventually downloads. Thus, the application recommendation system is a multi-faceted profile system in which the recommendation engine adjusts recommendations based on one or more profile attributes, e.g. the metrics.

In additional embodiments, in response to receiving a user selection of an application for download, the user is automatically notified whether the application for download is suitable based on the determined patter and the profile. For example, in FIG. 3 the recommendation engine may inform the user that a selected application is not suitable for the user device.

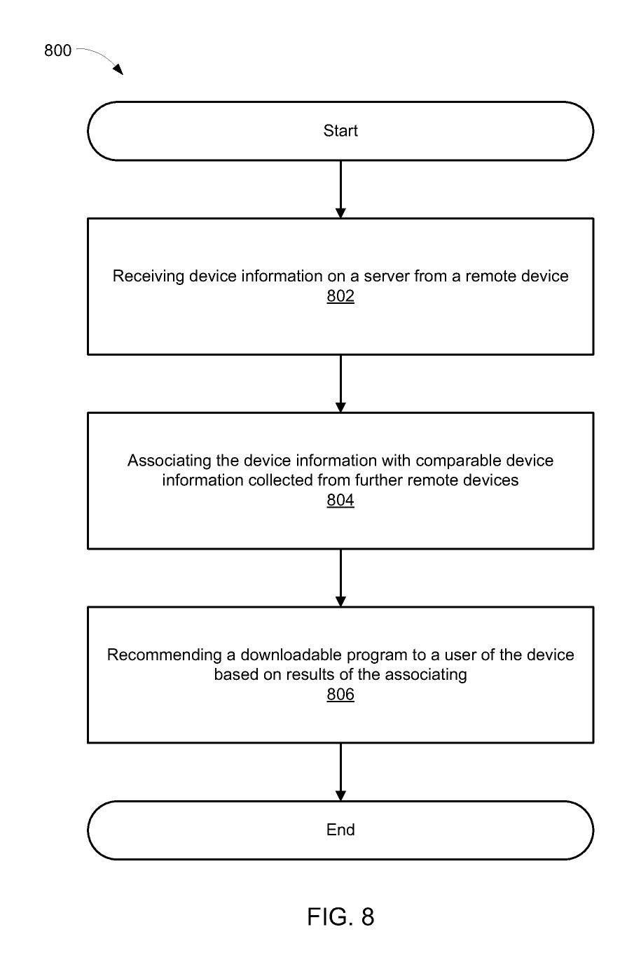

FIG. 8 depicts a flowchart 800 of an exemplary computer controlled method of automatic recommendation, according to an embodiment of the present invention. Although specific steps are disclosed in the flowchart 800, such steps are exemplary. That is, embodiments of the present invention are well-suited to performing various other steps or variations of the steps recited in the flowchart 800. The flowchart 800 can be implemented as computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In a step 802, device information is received on a server from a remote device. In various embodiments the remote device is a mobile computer system. For example, in FIG. 3 a user profile is collected from a user device (e.g. smart phone, tablet computer, laptop computer, desktop computer, etc.) with a profile collector. The profile collector may be any software, agent program, application, and/or hardware device that automatically collects information specific to the user profile from the user device. A recommendation engine residing on a server receives the user profile from the profile collector.

In some embodiments, the device information is a configuration of the device including: geography information of the device; system configuration of resources of the device; category sorted applications of the device; and use patterns of applications as used by the device. For example, in FIG. 3 the user's device information may be location, device system resources, category of installed applications, frequency of applications used, similar installed applications, use patterns of applications, hardware configuration of the device, possible incompatibilities, bandwidth, network usage, total memory, available memory, etc.

In further embodiments, the device information includes: a pattern of applications used on said device; a frequency of applications used on said device; a list of applications installed on said device; a list of applications removed from said device, and a categorical list of said applications on said device. For example, in FIG. 5 the number of metrics may include serial number, exact geo-location, IP address, memory, operating system, an installed program, hardware configuration, available memory, frequency of application use, types of applications installed, system resources, frequency of applications used on the device, similar applications installed on the device, types of applications installed on the device, similar applications deleted on the device, types of applications deleted on the device, etc.

In a step 804, the device information is associated with comparable device information collected and stored from further remote devices. For example, in FIG. 3 the recommendation engine receives the user profile from the user device, e.g. from the profile collector. The recommendation engine compares the user profile to other users' profiles that have been gathered by the recommendation engine.

In some embodiments, a downloadable program pack is recommended to the user based on the associating, wherein the downloadable program pack comprises a number of complementary programs. For example, in FIG. 6 the recommendation engine may build a recommendation pack for recommendation to the user device. The recommendation engine may group together a number of applications based on suitability for the user device and application category. The recommendation engine suggests the recommendation pack to the user device, where a user may choose to download one or more of the applications in the recommendation pack. In addition, the recommendation engine may build and suggest the recommendation pack based on system specifications, geo-location, or a user choice profile created by letting the user make a few initial application choices on a new device.

In a step 806, a downloadable program is recommended to a user of the device based on results of the associating. Furthermore, in some embodiments, the recommending is in response to receiving user selections of the user in an online application store. For example, in FIG. 3 the user may access the application store with the user device, e.g. with a web browser, purchase application, etc. When the user selects an application for purchase and/or download, the recommendation engine may provide a recommendation to the user based on comparing the user profile to other user's profiles. For example, the recommendation engine may inform the user that a selected application is not suitable for the user device.

In further embodiments, the device information and the comparable device information include geolocation information pertinent to the devices. For example, in FIG. 5 the recommendation engine compares the user profile to similar user profiles to identify specific applications users download in each category (e.g. user choices), the system profile on which they downloaded the applications, geo-location, etc.

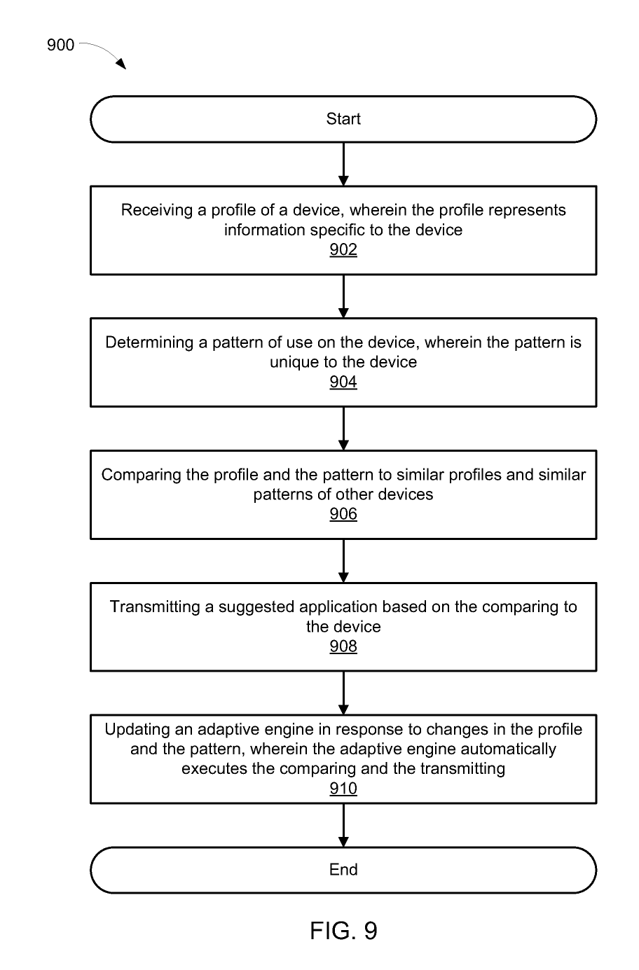

FIG. 9 depicts a flowchart 900 of an exemplary computer controlled method of automatic application recommendation, according to an embodiment of the present invention. Although specific steps are disclosed in the flowchart 900, such steps are exemplary. That is, embodiments of the present invention are well-suited to performing various other steps or variations of the steps recited in the flowchart 900. The flowchart 900 can be implemented as computer-executable instructions residing on some form of computer-usable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In a step 902, a profile of a device is received, wherein the profile represents information specific to the device. For example, in FIG. 3 a user profile is collected from a user device (e.g. smart phone, tablet computer, laptop computer, desktop computer, etc.) with a profile collector. The profile collector may be any software, program, application, and/or hardware device that automatically collects information specific to the user profile from the user device. A recommendation engine residing on a server receives the user profile from the profile collector.

In some embodiments, the profile is a configuration of the device including: geography of the device; hardware and operating system configuration of the device; applications on the device; and system resources on the device. For example, in FIG. 3 the user's device information may be location, device system resources, category of installed applications, frequency of applications used, similar installed applications, use patterns of applications, hardware configuration of the device, possible incompatibilities, bandwidth, network usage, total memory, available memory, etc.

In a step 904, a pattern of use on the device is determined, wherein the pattern is unique to the device. For example, in FIG. 5 a determined pattern of use created from the number of metrics may be unique to the user device. In some embodiments, the device is a desktop computer system. For example, in FIG. 3 the user device may be a smart phone, tablet computer, laptop computer, desktop computer, etc.

In some embodiments, the pattern of use includes: frequency of applications used on the device; similar applications installed on the device; types of applications installed on the device; applications deleted on the device; and types of applications deleted on the device. For example, in FIG. 5 the number of metrics may include serial number, exact geo-location, IP address, memory, operating system, an installed program, hardware configuration, available memory, frequency of application use, types of applications installed, system resources, frequency of applications used on the device, similar applications installed on the device, types of applications installed on the device, similar applications deleted on the device, types of applications deleted on the device, etc.

In a step 906, the profile and the pattern are compared to similar profiles and similar patterns of other devices. For example, in FIG. 3 the recommendation engine receives the user profile from the user device, e.g. from the profile collector. The recommendation engine compares the user profile to other users' profiles that have been gathered and stored by the recommendation engine.

In some embodiments, the similar profiles are selected based on geolocation. For example, in FIG. 5 the recommendation engine compares the user profile to similar user profiles to identify specific applications users download in each category (e.g. user choices), the system profile on which they downloaded the applications, geo-location, etc.

In a step 908, a suggested application is transmitted to the user via a communication based on the results of the comparing to the device. For example, in FIG. 3 the user may access the application store with the user device, e.g. with a web browser, purchase application, etc. When the user selects an application for purchase and/or download, the recommendation engine may provide a recommendation to the user based on comparing the user profile to other users' profiles. For example, the recommendation engine may inform the user that a selected application is not suitable for the user device.

In a step 910, an adaptive engine is updated in response to changes in the profile and the pattern, wherein the adaptive engine automatically executes the comparing and the transmitting. For example, in FIG. 6 the recommendation engine learns from users choices and automatically adjusts future recommendations on the basis of what the user eventually downloads. Thus, the application recommendation system is a multi-faceted profile system in which the recommendation engine adjusts recommendations based on one or more profile attributes, e.g. the metrics.

In some embodiments, in response to receiving a user selection of an application for download, a notification is sent to the user whether the new application is unsuitable for the device based on the pattern and the profile. For example, in FIG. 3 the user may access the application store with the user device, e.g. with a web browser, purchase application, etc. When the user selects an application for purchase and/or download, the recommendation engine may provide a recommendation to the user based on comparing the user profile to other user's profiles. For example, the recommendation engine may inform the user that a selected application is not suitable for the user device.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of automatic suggested application identification, said method comprising:
accessing a profile of a device, wherein said profile represents information specific to said device;
from said profile, accessing a determined pattern of use determined by said device, wherein said determined pattern is unique to said device;
comparing said profile including said determined pattern of use to similar profiles and similar determined patterns of use of other devices; and
identifying a suggested application based on said comparing.

2. The method of claim 1:
wherein an adaptive engine automatically performs said comparing and said identifying, and
further comprising:
communicating said suggested application to said device; and
automatically updating said adaptive engine in response to whether or not said device downloads said suggested application.

3. The method of claim 1 wherein said profile is a dynamic configuration of said device comprising:
geography of said device;
system resources of said device; and
category sorted list of applications on said device.

4. The method of claim 1 further comprising, in response to receiving a user selection of an application for download, automatically communicating a notification to said user whether said application for download is suitable based on said determined pattern and said profile.

5. The method of claim 1 wherein said determined pattern of use comprises:
frequency of applications used on said device;
a list of applications installed on said device; and
a list of applications removed from said device.

6. The method of claim 1 wherein said device is a mobile device.

7. The method of claim 3 further comprising selecting said similar determined patterns based on geolocation.

8. A method of automatic recommendation, said method comprising:
receiving device information on a server from a remote device;
associating said device information with comparable device information collected from further remote devices and stored on said server; and
recommending a downloadable program to a user of said device based on results of said associating.

9. The method of claim 8 wherein said device information is a dynamic configuration of said device comprising:
geography information of said device;
system resources of said device;
category sorted applications of said device; and
use patterns of applications as used by said device.

10. The method of claim 8 wherein said recommending is performed in response to receiving user selections of said user in an online application store.

11. The method of claim 8 wherein said device information comprises:
a use measurement of applications used on said device;
a list of applications installed on said device;
a list of applications removed from said device, and
a categorical list of said applications on said device.

12. The method of claim 8 further comprising, recommending a downloadable program pack to said user based on said associating, wherein said downloadable program pack comprises a plurality of complementary programs.

13. The method of claim 8 wherein said remote device is a mobile computer system.

14. The method of claim 8 wherein said device information and said comparable device information include geolocation information pertinent to said devices.

15. A system comprising:
a processor; and
memory coupled to the processor, wherein said memory comprises instructions that when executed cause said system to perform a method of automatic application recommendation, said method comprising:
receiving a profile of a device, wherein said profile represents information specific to said device, wherein said profile comprises a determined pattern of use as determined on said device;
comparing to similar profiles of other devices;
transmitting a suggested application based on results of said comparing to said device; and
updating an adaptive engine in response to changes in said profile, wherein said adaptive engine automatically executes said comparing and said transmitting.

16. The system of claim 15 wherein said profile of said device further comprises:
geography of said device;
hardware configuration of said device;
applications on said device; and
system resources on said device.

17. The system of claim 15 wherein said method further comprises, in response to receiving a user selection of an application for download, automatically sending a notification to said user whether said new application is unsuitable for said device based on said profile of said device.

18. The system of claim 15 wherein said determined pattern of use comprises:
frequency of applications used on said device;
a list of applications installed on said device; and
a list of applications removed from said device.

19. The system of claim 15 wherein said device is a desktop computer system.

20. The system of claim 15 wherein said method further comprises selecting said similar profiles based on geolocation.
